(19) United States
(12) Patent Application Publication
(10) Pub. No.: US 2004/0032045 A1
(43) Pub. Date: Feb. 19, 2004

(54) Method and device for producing an insulated cable

(76) Inventors: Werner Lepach, Schwabach (DE); Georg Horndler, Barthelmesaurach (DE); Hans Joachim Burisch, Wulfrath (DE)

Correspondence Address: GREER, BURNS & CRAIN, 300 S WACKER DR, 25TH FLOOR, CHICAGO, IL, 60606, US

(21) Appl. No.: 10/239,936

(22) PCT Filed: Mar. 19, 2001
(86) PCT No.: PCT/EP01/03109

(30) Foreign Application Priority Data
Apr. 3, 2000 (DE) 100 16 518.4

(51) Int. Cl. H01B 13/00; B65H 75/22

(52) U.S. Cl. 264/83; 242/608; 242/604

(57) ABSTRACT

The invention relates to a method for manufacturing a cable including the following steps: Manufacturing of a cable with an electrical conductor which comprises at least one part consisting of a cross-linkable polymer; coiling of said cable to form a bunch; treating of said bunch under process conditions, which cause a cross linking of the cross-linkable polymer. The invention further relates to an apparatus for manufacturing a cable, which comprises at least one element formed by a cross-linkable polymer, including: A polymer applying device by which said polymer component is put on, put into or led in any other manner to the cable; a coiling device by which said cable, that was supplied with a cross-linkable polymer, is coiled to form a bunch; a bunch treatment device in which said bunch is treated under predetermined process conditions which at least partially cause the cross-linking of said cross-linkable polymer component.

The present invention is related to a method and an apparatus for manufacturing an insulated cable. A further object of the invention is also the cable manufactured by the method and respectively the apparatus according to the invention.

In the following, the term “cable” in the sense of the present invention denotes an electrical or optical conductor which is enveloped by an insulation or any other kind of coating. This conductor can consist of arbitrary material, preferred are materials of copper and the like. Furthermore, the conductor may consist of one single wire, it also may consist of a plurality of wires and especially of thin flexed wires. Further, a cable in the sense of the present invention may consist of a plurality of strains which are insulated against each other, wherein the corresponding single cables can be arranged to each other in an arbitrary configuration, for example, parallel in a plane as a flat cable, in a round cable, in a cable in which the single conductors are twisted or arranged to each other in a comparable manner, wherein with all these cables with a plurality of conductors insulated with respect to each other, also additional insulation coatings can be used. These insulation coatings may encircle single conductors or all conductors. Additional screening coatings encircling screening groups of conductors or all conductors consisting of a wire cloth may be used.

A particularly preferred application for the cables mentioned here is the use of these cables in automobile production. The invention therefore in the following is described with reference to this application. It is to be noted, however, that this description is just examplatory and should not be considered as a limitation of the applicability of the invention.

In automobile production, a plurality of cables is used to supply single consumers with electrical energy, respectively to send them information signals. Especially for cables which are used inside the engine compartment, the requirements concerning the temperature resistance are high. On the other side, the requirements today are high concerning the environmental pollution of the insulating materials.

Polymers which are cross linked after being extruded have very good characteristics in regard of this aspect. The cross-linking leads especially to an improved temperature resistance of the material.

Cross-linkable polymer materials are known in the state of the art and described in a plurality of documents. Examples for such documents, which directly also describe polymers applicable for cable insulation, are:

U.S. Pat. No. 5,679,192, U.S. Pat. No. 5,384,879, U.S. Pat. No. 6,005,055, U.S. Pat. No. 4,413,066, U.S. Pat. No. 4,297,310, U.S. Pat. No. 4,351,876, U.S. Pat. No. 4,397,981, U.S. Pat. No. 4,446,283, U.S. Pat. No. 4,456,704, EP 0 475 064, WO 91/09075, GB 2,028,831, EP 0 193 317, EP 0 207 627.

There are several possibilities to provide the cross-linking of the polymer material.

One of the possibilities to provide the cross-linking of a polymer is the treatment with ionisating rays as described in the above mentioned U.S. Pat. No. 5,679,192.

The second method is the CV-method, wherein CV is the abbreviation for “continuous vulcanization”. This tube-steam method until now is limited for applications with thin cables.

Another possibility which is preferably described here is the Silan-method as described in the U.S. Pat. No. 6,005,055. With these products, the cross-linking is effected by the utilization of heat. On this method will be, although not exclusively, focused with respect to the applicability of the present invention.

It is the object of the present invention to provide a method for manufacturing electrical cables which is reliable and cheap in cost and which allows to use polymer insulation materials changeable under the influence of a change of temperature.

This problem according to the invention is solved by the object of claim 1.

Preferable embodiments of the invention are object of the sub-claims.

According to the invention, the cable is encircled by a polymer insulation material in a continuous process. Thereafter, a cable bunch is created.

This cable bunch is created by coiling the cable with a suitable coiling apparatus to a bunch. The coiling to a bunch can be achieved with different bunch reception apparatus. Especially preferred is the coiling on a spool, but also the coiling in a coiling barrel. Before further treatment, according to the coiling methods and the used bunch reception apparatus, respectively, the latter can be separated from the bunch, so that afterwards a coilless bunch will be further treated.

Furthermore, it is preferred to use a coiling method which itself uses during coiling a coiling auxiliary apparatus, for example a steel spool in the form of a truncated cone or a steel core, and the bunch after coiling is separated from this coiling auxiliary apparatus. The bunch only comprises supporting means as, for example, a thin coil core or the like which supports the bunch during manufacturing and eventually also when drawing off.

In the next step in manufacturing the bunch can be subjected to a predetermined rest period depending on the material of the polymer.

After this rest period, in the following manufacturing step a heat treatment of the bunch takes place.

The term “heat treatment” refers especially to a treatment which increases the temperature of the bunch. In the sense of the invention it is also possible, if it is advantageous with regard to the polymer material used or the other conditions of the method, to accomplish the heat treatment as heat reducing treatment, i.e. as cooling. In the following, always the term “heat treatment” is used, even if a cooling treatment is mentioned.

The heat transmission can be accomplished by direct contact of the means to be heated with the bunch, by convective heat transmission or by heat transmission by radiation.

Especially preferred is the heat transmission by a heat containing medium, especially a liquid medium like water and the like, a gasiforme medium like steam which can be saturated or unsaturated, but also air or another kind of a gas.

In the sense of the present invention, the term “water” respectively “water bath” and the like, is used as synonym for each liquid bath. A water bath, therefore, can be filled with a different liquid instead of only water. Under the term “water” in this sense also is understood water, which contains additional substances which stimulate the cross-linking but also additional substances which simplify or accelerate the drying process or the following manufacturing processes.

Under the term “steam”, all essentially gasiforme fluids are to be understood. Therefore, not only steam but also, if it is not directly mentioned, air and all kinds of gas-water-air mixtures.

The term “medium” is to be understood as generic term for the terms ‘water’ in the sense of the present invention and ‘steam’ in the sense of the present invention. A medium therefore can be an arbitrary liquid as well as an arbitrary gas.

The method according to the invention has the advantage, that the heat treatment takes place at a time when the cable has already been formed to a bunch. Especially if, as especially preferred, one uses the bunch form for the heat treatment which is also provided for the later further treatment or utilization of the cable, the additional expense necessary for the heat treatment is reduced to a minimum.

One can also heat treat the cable in the form in which it is usually supplied to the consumer and therefore achieve an improved product without increasing the expense, for example for a continuous manufacturing.

Usually, the heat treatment device is arranged stationary, for example directly after the extrusion process.

But it is also possible to arrange the heat treatment device mobile. It can be arranged, for example, as a heat chamber or as a plurality of heat chambers on a transport device, i.e. on a truck, a railway wagon or the like so that the cross-linking takes place on the carrying distance between the manufacturer and the consumer which is necessary anyway, so that no additional time expense is necessary.

If the necessary treatment for the cross-linking takes place with water or another liquid, respectively with steam or the like, the bunch has to be dried after the heat treatment.

This can take place as drying action in the air, but also an additional drying action can take place during which the bunch is exposed to dry air with the temperature of the environment or, preferably, higher temperature which is used to dry the bunch.

Preferably, the drying action takes place in a vacuum chamber. In this case, the bunch is brought into-a chamber which then is evacuated or in a different manner connected with a vacuum source. The vacuum leads to a decrease of the steam pressure which leads to an evaporation of the liquid inside the bunch and, therefore, to a very rapid drying.

The kind of bunches and the kind of bunch reception devices can be formed in different manner.

It is possible to use conventional bunch reception devices, especially conventional coils and conventional barrel coil devices and the like. Condition therefore is only that these coils are suitable for the respective heat transmission method.

When using conventional coils, a water bath is especially suitable for the heat transmission. Thereby, the single bunches are transported to a water bath, which is able to receive one or a plurality of bunches. The bunch is manually or, preferably, full-automatically brought into the liquid bath with a corresponding device and taken out of the water bath again after a predetermined time.

Instead of placing the bunch in a liquid bath, the action also can be formed in reverse direction, so that the liquid bath, respectively the basin or the basins forming this bath, are first without liquid, then the bunch is placed into the basins and then the liquid is supplied and after finishing this step is again removed from the bath.

For this kind of method, especially coilless bunches are suitable but also cables which are coiled on plastic drums and the like.

If the bunch is placed into a water bath, there is the danger that the heating water does not reach all bunches in the same manner. This is problematic if the temperature or the period is thus, that in these regions a cross-linking is not achieved.

According to an embodiment of the invention, it is suggested to provide means which cause that the heat transmitting medium forcingly streams through and/or streams around the bunch, wherein preferably the kind of streaming through and/or streaming around is predetermined.

The invention suggests a plurality of preferred methods:

According to the first method means are provided, which cause a streaming through of the medium through the bunch. The are connected with the bunch and especially part of the bunch reception device, are provided.

In a preferred embodiment, the bunch comprises a hollow cylindrical, conical or differently formed coil core which is sealed with respect to the environment.

In this coil core, stream openings are provided through which the medium is able to stream. The medium is then passed into the coil core, streams through the openings and the bunch and exits at the outer face of the bunch.

By selection of the bunch parameters and the number, form and size of the openings, the stream characteristics can be determined very exactly. If, for example, a conical coil is used as bunch reception device, less openings will be provided in the region in which there are less coil layers than in other regions.

In a second embodiment, an auxiliary means is used to ensure optimal streaming through the bunch with the medium. This can be, for example, a sealed cylindrical or conical device which is pushed into the internal of a coilless bunch or which is put on the coilless bunch. In a corresponding manner, openings are also provided here through which the medium can stream into the bunch.

In a third embodiment of the method, the aforementioned two methods are combined with each other, i.e., the bunch reception device is provided such that it is especially suitable for the streaming through of the medium. Additionally, devices are used to improve the streaming through.

To accomplish an optimal streaming through of the bunch, preferably a corresponding pressure difference between the stream inlet and the stream outlet are adjusted. This can be accomplished if in the interior of the coil core of the bunch an excess pressure of the streaming medium is created and at the same time in the exterior region of the bunch, there is environmental pressure. Reversely, this can be accomplished if there is an excess pressure in the exterior region of the bunch, i.e. if the bunch is brought into a chamber and if there is environmental pressure in the interior of the bunch, especially in the coil core.

But the pressure difference can also be accomplished if the medium is supplied with environmental pressure or exceed pressure, but on the other side of the stream, there is low pressure. Thereby, it is possible, for example, to suck the medium from the outside through the bunch by low pressure in the coil core.

If the coil core is provided with one or two flanges, the streaming through of the bunch can be accomplished in that corresponding inlet and/or outlet openings are provided in the flanges. In this modification, the streaming medium, for example, can be supplied to the bunch through openings in one of the flanges and brought away through openings in the other flange. Here also the adjustment with exceed pressure/low pressure as described before is possible.

In a further process variant, which can be combined with the aforementioned modifications, the stream movement is accomplished by a relative movement between the bunch and the streaming medium.

The relative movement can be created by a streaming around of the medium in a channel adapted to the bunch or with a plurality of channels, so that an optimal penetration of the bunch with the medium is accomplished.

In another embodiment, the bunch itself can be moved relative to the medium. This is, for example, accomplished by arranging the bunch eccentrically on a rotating arrangement. If the arrangement rotates, the bunch is moved relatively to the medium. Additionally, a rotation of the bunch itself can be provided.

Besides the aforementioned method to heat the cable by means of a medium, alternatively or additionally also different methods of heating can be used.

The consumers of such cables usually request a continuous electrical conductivity of the cable. This means that inside the cable, no ruptures of the electrical conductor or no locations with reduced electrical conductivity may occur. In such cable bunches, it is possible to connect the beginning and the end of the cable inside the bunch with an electrical power source, without conducting current through the bunch. Thereby, a considerable warming of the bunch is achieved. Preferably, therefore a control device will be provided which adapts the voltage and especially the current to the desired warming.

This method can be combined with other methods, i.e. that for example, during this resistor warming, air is blown through the bunch to avoid a heat accumulation of the coil layers which are closer to the coil core.

In all embodiments of the method described here, preferably control devices can be provided which detect uniform warming of the coil good inside the bunch. Therefore, at different locations of the coil good, sensors can be arranged which measure the respective temperature at these locations. Furthermore, it is possible to measure the temperature of the inlet and the outlet medium to determine the heat reception of the coil from of the temperature difference.

Especially, if a bunch reception device or a supporting device is used for the bunch, it may be advantageous to arrange temperature sensors at the bunch reception device or the supporting device. This can be facilitated in the manner that the temperature sensors, for example thermo elements, temperature sensitive resistors or the like are provided with electrical wires which lead to a contact point of the coil reception device. Thereby, it is possible to couple the coil reception device, for example, in the heat treatment device, automatically with a control device, which measures the temperature at selected locations of the coil reception device.

The spool reception device also may provide protrusions, which protrude into the coil wares, for example, a mean spool flange within a usual spool at which temperature sensors of this manner are arranged.

In a preferred embodiment of the method, a bunch is used which is arranged on a bunch reception device. This bunch reception device in this embodiment is formed as a divisible plastic spool comprised of a cylindrical, but preferably a conical internal coil core.

Such a spool is described, for example, in the EP 0 672 016 B1 and the EP 0 628 013 B1 as well as in the U.S. Pat. No. 5,593,108. An advantageous method to coil on such a spool cable to a bunch is object of the EP 0 343 211 B1 as well as of the U.S. Pat. No. 5,255,863 The coil spool described there—especially in conical form—has the advantage that the cable is coiled on this spool coil, the coil spool then is transported to the consumer, the cable there is drawn off the coil spool, (for example for manufacturing the cabletrees in the car industry), the coil spool is then taken apart, which happens by taking of the flange at the end of the coil core with the smaller diameter, coil cores and flanges are then stacked and then are sent back to the cable manufacturer space-saving and low in weight.

To use such a coil in a process in which the bunch is streamed through by a medium, the invention suggests to use sealings which provide a closed room in the inside of the coil core.

These seals can be carried out in an additional device which is part of the heat treatment device or can also be part of the coil. So it is especially possible to form the connection between the detachable flange and the coil core in such a way that the connection after mounting of the flange creates a sealed coil room.

It has to be mentioned, however, that in some coil devices a bore in the upper flange is used as centering assistant.

For a coiling device for which this is not the case, for which for example the centering takes place at the outer peripheral direction of the flange, the flange can be provided full flat and then comprises an encircling seal, for example, in form of an O-ring with which it is sealed against the coil core.

The method according to the invention has considerable advantages with respect to the state of the art.

The cable manufacturing process is usually a continuously running process. The cross-linking of polymer materials requires the application of a certain temperature extending over a determined time period which is long compared to the cable manufacturing.

With the process suggested in the invention, the cable manufacturing can take place as usual. This means, for example, that from a copper material a plurality of fine wires is drawn afterwards the wires are flexed to a flex in a flexing machine, that this flexing machine is followed by an extrusion machine in which the flex is provided with a polymer insulating layer. Afterwards the cable is coiled in a conventional manner so that this part of the cable manufacturing process does not have to be changed.

The heat treatment necessary for the cross-linking of the polymer material takes place in a method step succeeding this step. Since the cross-linking can take place directly in the bunch, it is not necessary to provide devices with which the cable can be uncoiled and again coiled. Since furthermore the bunch is supplied to the heat treatment in the form in which it is later supplied to the consumer, no additional process steps exceeding the heat treatment itself are necessary to bring the flexed cable into a form adaptable for the consumer.

Therefore, the method can be used especially economical and especially allows a cheap in cost replacement of polluting materials.

Further advantages, features and application possibilities of the present invention arise from the following description of the embodiments.

Therein, the only FIGURE shows a cross section through a bunch reception device which preferably can be used for the process according to the invention.

The coil shown schematically in the FIGURE essentially corresponds to the coil which is described in the EP 0 672 016 B1. The description of the coil there is made part of the disclosure of the present application by this denotation.

The coil is formed rotation-symmetrically to a rotational axis 20.

It comprises a coil core 5 which is formed conically and which is connected one-piece with an upper flange 3 (shown according to the FIGURE).

At the lower end of the coil core 5 with the smaller end, a flange 7 is provided which is, as described the aforementioned patent describes, connected detachable with the coil core.

An encircling edge 8 facing downwards is formed at the flange 7 with which the flange is received in a coil device respectively during transport is set up on a palette on a coil which lying downwardly under the flange.

On this coil core is, as shown schematically coiled a cable 6 as described in the aforementioned patent application EP 03341212B1. Such a bunch is called a double conical bunch.

The coil core itself is—indicated schematically—provided with a plurality of openings 22.

On the coil core, a top 1 is put on, which comprises an upper platform part and a conical extension la adjacent thereto.

Arranged encircling this conical extension, there is a rubber seal, preferably an O-ring-seal 2.

The seal top 1 can be connected with the coil core by a clamping or connecting device (not shown). But it is also possible to form the seal top 1 from a material with higher weight so that it fixedly sticks because of its self weight and the friction created by the seal ring 2.

During application in which low pressure is created in the coil core, no additional weight in the seal top needs to be arranged. Here the usual dead weight (for example, of a plastic plate) suffices for a first sealing effect which then is further amplified as a result of the low pressure.

In the lower region of the coil a seal plate 12 is shown which as well comprises an encircling rubber seal for example an O-ring-seal. This seal is so dimensioned that is comes in sealing contact with the encircling rings 8 of the flanges if the coil is put on the seal plate 12.

The seal plate 12 furthermore comprises a conical extension 14 which is provided to be pushed into the conical extension 9 of the detachable flange 7.

In the seal plate 12, there are inlets and outlets 16, respectively, which cause a stream connection.

The function of this embodiment is as follows:

The coil supplied is supplied to the cable manufacturer. Thereby, a plurality of coil cores 5 is being stacked into each other and as well a plurality of flange plates 7 which corresponds to the number of stacked coil cores is stacked.

The flange 7 is, as described in the aforementioned patent, put on the coil core and preferably fixedly connected with it.

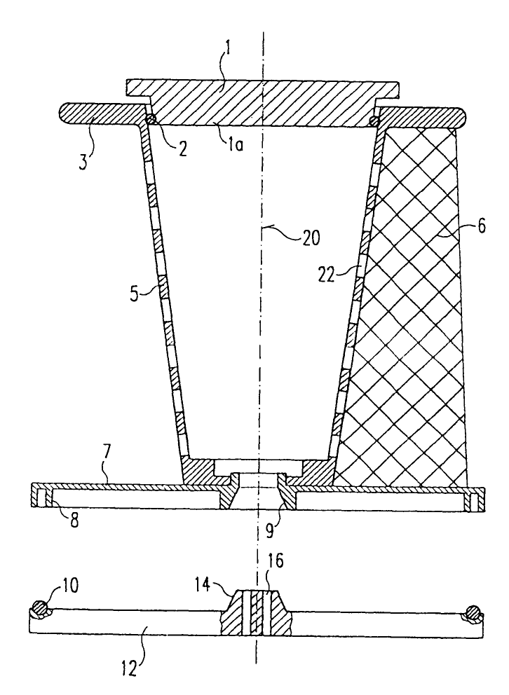

In the following the coil core with the flange is brought into a coiling device and a cable with a cross-linkable polymer is coiled onto the coil. The cable is indicated schematically on the right hand side of the drawing in FIG. 6.

In the following, the coil spool is taken out of the coil device and manually or automatically the seal top 1 is put on and the bunch consisting of coil core and flange 7 is put on the seal plate 12. Thereby, a sealed connection of the internal of the coil core is created, whereby the coil core is connected to a pressure or vacuum source by a stream connection 16.

For heat treatment now a medium can be filled into the coil core: either warm air, steam or water. This medium is pressed into the bunch via openings and can escape to the outside.

Reversely, it is possible to put the bunch as one piece in a water bath whereby the seal plates 12 preferably are already arranged fixed or displaceably.

The stream connections 16 then are connected with a low pressure source and water, steam or warm air is sucked through the bunch and the openings and drawn off by the openings 16.

In one embodiment of the method which requires especially low investment costs, altogether two basins are provided, which, for example, provide each a size of 3 x 3 meters.

The basins are higher than the height of the coils.

In the first action state, just the first basin is filled with water of about 90-95° C. while the second basin is without water.

In the first basin preferably the water is guided via the inlet openings 16 of the seal plate 12 into the coil core to reach a controlled streaming through the bunch. As already mentioned, also the reverse variant is possible, i.e. that water is sucked into the bunch.

In the second basin at the beginning now water is provided. Here hot air is sucked through the coil or respectively is blown through the coil to dry the bunch.

In the next action state, the functions of basin 1 and basin 2 are interchanged. The coils dried in basin 2 are taken out of the basin and new untreated coils are put in. After this, the water from basin 1 is led into basin 2 and the coils in basin 1 are dried with warm air.

This action is repeated correspondingly.

The advantage of this method is that the coils just have to be brought once into the basin. This bringing in can succeed manually, with a crane or preferably with a handling device, a conveyor belt or the like.

When changing from the heating action to the drying action a transport of the bunches is not necessary.

Since the rest periods in both basins are equal a reliable drying and reliable heat treatment of the coils is provided.

1. Method for manufacturing a cable with the following method steps:
manufacturing of a cable with an electrical conductor which at least comprises one part consisting of a cross-linkable polymer;
coiling of this cable to a bunch;
treating of this bunch under process conditions which cause a cross-linking of the cross-linkable polymer.

2. Method according to claim 1 characterized in that the bunch is arranged on a bunch reception device and during the cross-linking treatment remains on this bunch reception device.

3. Method according to claim 1, characterized in that this bunch is manufactured with a coil auxiliary device which is displaced form the bunch before cross-linking treatment.

4. Method according to claim 3 characterized in that the bunch is manufactured with a bunch supporting device and under use of a coil auxiliary device wherein the bunch supporting device after displacement of the coil auxiliary device remains in the bunch.

5. Method according to at least one of the claims 1 to 4, characterized in that a process step is preset to the process step which causes the cross-linking during which the bunch is subjected to a predetermined rest period.

6. Method according to at least one of the claims 1 to 5, characterized in that the bunch for the cross-linking treatment is brought into at least one chamber in which these process conditions necessary for the cross-linking are set.

7. Method according to at least one of the claims 1 to 6, characterized in that this method conditions are achieved by a streaming through of the bunch is by a liquid and/or gasiform medium.

8. Method according to at least one of the claims 1 to 7, characterized in that these method conditions are achieved by a streaming around of the bunch by a liquid and/or gasiform medium.

9. Method according to at least one of the claims 1 to 8, characterized in that these method conditions are achieved by a forcingly streaming through and/or streaming around by a liquid and/or gasiform medium.

10. Method according to at least one of the claims 1 to 9, characterized in that the cross-linking treatment consists of at least 2 process steps following each other wherein these process steps comprise differences with respect to the method conditions and/or the kind of the medium streaming through the bunch.

11. Apparatus for manufacturing a cable which at least comprises one element which is formed by a cross-linkable polymer with:
a polymer applying device through which this polymer component is put on, put into or led in any other manner to the cable;
a coil device with which this cable provided with the crosslinkable polymer is coiled to a bunch;
a bunch treatment device in which this bunch is treated under predetermined process conditions which at least partially cause the cross-linking of the this cross-linkable polymer component.

12. Apparatus according to claim 11, characterized in that this treatment device comprises at least one chamber in which this process conditions are set.

13. Apparatus according to claim 12, characterized in that this chamber is closed to all sides, preferably sealed with respect to the exterior.

14. Apparatus according to claim 12, characterized in that at least one chamber of this treatment device is partially opened, especially is formed as chamber partially open to the upper side.

15. Bunch reception device, especially for carrying out the process according to at least one of the claims 1 to 10, especially under use of the apparatus according to at least one of the claims 11 to 14 wherein this bunch reception device comprises at least one device through which a gasiforme or liquid medium can be led through this bunch.

16. Bunch reception device according to claim 15, characterized in that the bunch reception device is formed as coil spool preferably as dividable coil spool which comprises at least one wall which is arranged adjacent to the coiled cable and that this device is formed as one or comprises a plurality of openings in this wall through which the medium streams into the bunch.

17. Bunch reception device according to claim 15 or 16, characterized in that the bunch reception device at least at the time at which the bunch is subjected to a treatment in the treatment device comprises at least one sealed chamber which is in stream connection with an excess or low pressure source for a liquid or gasiforme medium.

18. Cable bunch with a cable which comprises an electrical conductor and at least one element of a cross-linked polymer which preferably is formed as insulating layer, characterized in that this cable bunch is manufactured according to at least one of the claims 1 to 10 and/or under use of the apparatus according to at least one of the claims 11 to 14 and or under use of a bunch reception device according to at least one of the claims 15 to 17.
